(19) United States
(12) Patent Application Publication
(10) Pub. No.: US 2025/0217904 A1
(43) Pub. Date: Jul. 3, 2025

(54) ELECTRIC-THERMAL INTEGRATED ENERGY CONTROL METHOD BASED ON SAFETY AND ECONOMY

(71) Applicant: NANJING UNIVERSITY OF POSTS AND TELECOMMUNICATIONS, Nanjing, Jiangsu (CN)

(72) Inventors: Chunxia DOU, Nanjing, Jiangsu (CN); Hao WANG, Nanjing, Jiangsu (CN); Dong YUE, Nanjing, Jiangsu (CN); Zhijun ZHANG, Nanjing, Jiangsu (CN)

(73) Assignee: NANJING UNIVERSITY OF POSTS AND TELECOMMUNICATIONS, Nanjing, Jiangsu (CN)

(21) Appl. No.: 18/851,357

(22) PCT Filed: Oct. 24, 2022
(86) PCT No.: PCT/CN2022/126957

§ 371 Date: Sep. 26, 2024

(30) Foreign Application Priority Data
Jul. 18, 2022 (CN) 202210838509.8

(51) Int. Cl. G06Q 50/06; G06N 3/08; G06Q 10/04

(52) U.S. Cl. CPC G06Q 50/06; G06N 3/08; G06Q 10/04

(57) ABSTRACT

An electric-thermal integrated energy control method is provided. The method comprises predicting renewable energy and multivariate loads in an integrated energy system based on a pretrained SA-PSO-BP neural network; constructing an objective function of the integrated energy system, and adding power network constraints and heat network constraints for optimal scheduling; and obtaining an optimal solution of the objective function by means of a SA-PSO algorithm based on prediction results of the renewable energy and the multivariate loads, and controlling the integrated energy system according to the optimal solution of the objective function; wherein, a training process of the SA-PSO-BP neural network comprises: training a BP neural network by means of a feature training set, and iterating and updating weights and thresholds in the BP neural network in the training process by means of the SA-PSO algorithm to obtain the SA-PSO-BP neural network.

### FIELD

The invention belongs to the field of energy system control, and particularly relates to an electric-thermal integrated energy control method that is both safe and economic.

### BACKGROUND

With the constant development of technology and economy, the demand for energy in the fields of social production and life becomes greater, and the continuous consumption of fossil energy leads to ever serious energy and environmental problems. To satisfy energy and environmental protection requirements, the incorporation of low-carbon, clean and green renewable energy into existing energy systems becomes a preferred strategy of all countries. However, the randomness and intermittence of renewable energy such as wind power and photovoltaic power greatly seriously hinders the consumption to wind power and photovoltaic power of integrated energy systems, making it of great importance to predict power generation of renewable energy.

After being proposed, integrated energy systems formed by interconnected heterogeneous energy such as electric energy, thermal energy and gas energy are widely applied, break down barriers between different types of energy, enhance mutual backup between energy, and effectively improve energy supply stability.

However, existing study of electric-thermal integrated energy systems mainly focuses on economic optimization and improvement of the infiltration rate of renewable energy, and study on the safety of the electric-thermal integrated energy systems is insufficient. Because of some uncertain factors such as wind and photovoltaic power output of the electric-thermal integrated energy systems and the requirements for multivariate loads, safety accidents such as voltage violations of the system may occur.

### SUMMARY

The objective of the invention is to provide an electric-thermal integrated energy control method based on safety and economy to guarantee safe operation of a system and realize economically optimal scheduling.

To fulfill the above objective, the invention adopts the following technical solution:

In a first aspect, the invention provides an electric-thermal integrated energy control method based on safety and economy, comprising:
predicting renewable energy and multivariate loads in an integrated energy system based on a pretrained SA-PSO-BP neural network;
constructing an objective function of the integrated energy system, and adding power network constraints and heat network constraints for optimal scheduling; and
obtaining an optimal solution of the objective function by means of a simulated annealing-particle swarm optimization (SA-PSO) algorithm based on prediction results of the renewable energy and the multivariate loads, and controlling the integrated energy system according to the optimal solution of the objective function;
wherein, a training process of the SA-PSO-BP neural network comprises:
determining a topological structure of a BP neural network according to preferred features and an output power of the integrated energy system; acquiring correlated features of wind power, photovoltaic power and electric-thermal loads in the integrated energy system, preprocessing and screening the correlated features to obtain preferred features, and constructing a feature training set; and
training the BP neural network by means of the feature training set, and iterating and updating weights and thresholds in the BP neural network in the training process by means of the SA-PSO algorithm to obtain the SA-PSO-BP neural network.

Preferably, a method for preprocessing the correlated features comprises:
eliminating abnormal data from the correlated features of the wind power, the photovoltaic power and the electric-thermal loads based on a 3δ principle respectively according to the following formulas:

$${\overline{p}}_{i} = \frac{{{\sum }^{n}}_{i = 1} {p}_{i}}{n} \\ δ = \sqrt{\frac{1}{n - 1} {\sum }_{i = 1}^{n} {( {p}_{i} - \overline{p} )}^{2}} \\ {p}_{e} = \vert {p}_{i} - \overline{p} \vert$$

where, pᵢ denotes an i^{th} sample value of a same feature, p̅ᵢ denotes a sample mean, δ denotes a reference standard value, n is the number of samples, and pₑ is a residual error; when the residual error pₑ of one correlated feature is greater than 3δ, the correlated feature will be eliminated; and
filling the correlated features of the wind power, the photovoltaic power and the electric-thermal loads with missing data by means of a Lagrange interpolation method according to the following formula:

$$L ( x ) = {\sum }_{i = 0}^{n} {y}_{i} {\prod }_{j = 0 , j \neq i}^{n} \frac{x - {x}_{i}}{{x}_{i} - {x}_{j}}$$

where, xᵢ denotes a time of a (i+1)^{th} value point, yᵢ indicates a feature value of the (i+1)^{th} value point, xᵢ denotes a feature value of a j^{th} value point, and L(x) denotes a feature interpolation corresponding to a given time x.

Preferably, a method for screening the correlated features to obtain preferred features comprises:
estimating a correlation between the correlated features by means of a Pearson correlation coefficient according to the following formula:

$${ρ}_{XY} = \frac{Cov ( X , Y )}{{σ}_{X} {σ}_{Y}}$$

where, X denotes a feature value vector, Y denotes an actual value vector required by the wind power, the photovoltaic power, the electric loads or the thermal loads, and ρ_{XY} denotes a correlation degree between X and Y; C ov(X, Y) denotes a covariance of X and Y, and σ_{X} and σ_{Y} respectively denote a standard deviation of X and a standard deviation of Y; and
screening the preferred features from the correlated features of the wind power, the photovoltaic power and the electric-thermal loads according to the correlation degree ρ_{XY}.

Preferably, a method for constructing the objective function of the integrated energy system comprises:
normalizing the sum f₁ of absolute deviations of node voltages of the integrated energy system at different times into F₁; and
integrating an electricity selling cost C_{E}, a gas purchase cost C_{GAS} a device operating cost C_{OP} and a wind and photovoltaic power curtailment penalty cost C_{GWP} into an economic cost f₂, and normalizing f₂ into F₂;
wherein, a formula for constructing the objective function is:

$$\{ \begin{matrix}F = min ( {λ}_{1} {F}_{1} + {λ}_{2} {F}_{2} ) \\ {F}_{1} = \frac{{f}_{1}}{{f}_{1}^{m ax}} \\ {F}_{2} = \frac{{f}_{2}}{{f}_{2}^{m ax}} \\ {f}_{1} = {\sum }_{i = 1}^{{N}_{V}} {\sum }_{t = 1}^{T} \vert {\tilde{V}}_{i , B} \vert \\ {f}_{2} = {C}_{E} + {C}_{GAS} + {C}_{OP} + {C}_{GWP}\end{matrix}$$

where, and λ₁ and λ₂ are respectively weights of F₁ and F₂, f₁^{max} is a maximum value of the sum of the absolute deviations of the node voltages of the integrated energy system, f₂^{max} is a maximum power output cost of devices in the integrated energy system, T is a total operating time of the integrated energy system, N_{V} is the number of electric nodes, and \tilde{V}_{i,B}^{t} is a difference between the voltage of an i^{th} electric node at a time t and a safety margin.

Preferably, the difference \tilde{V}_{i,B}^{t} between the voltage of the i^{th} electric node at the time t and the safety margin is calculated by:

$${\tilde{V}}_{i , B}^{t} = \{ \begin{matrix}{V}_{i , B}^{t} - {V}_{m i n} & , {V}_{i , B}^{t} < {V}_{m i n} \\ 0 & , {V}_{m i n} \leq {V}_{i , B}^{t} \leq {V}_{m ax} \\ {V}_{i , B}^{t} - {V}_{m ax} & , {V}_{i , B}^{t} > {V}_{m ax}\end{matrix}$$

where, V_{i,B}^{t} denotes a per-unit value of the voltage of the i^{th} electric node at the time t, Vₘₐₓ denotes an upper limit of the per-unit value of the node voltage, and Vₘᵢₙ denotes a lower limit of the per-unit value of the node voltage.

Preferably, under the influence of a heat network, the per-unit value V_{i,B}^{t} of the voltage of i^{th} electric node is corrected by means of a Newton-Raphson method as follows:
relative injected powers of the electric nodes are expressed as:

$$\{ \begin{matrix}{P}_{i} = {P}_{chp , i} + {P}_{es , i} + {P}_{wd , i} + {P}_{pv , i} - {P}_{eb , i} - {P}_{load , i} \\ {Q}_{i} = {Q}_{chp , i} + {Q}_{es , i} + {Q}_{wd , i} + {Q}_{pv , i} - {Q}_{eb , i} - {Q}_{load , i}\end{matrix}$$

where, pᵢ and Qᵢ respectively denote an active power and a reactive power injected into the i^{th} electric node, p_{chp,i} and Q_{chp,i} respectively denote an active power and a reactive power of a CHP unit in the i^{th} electric node, p_{es,i} and Q_{es,i} respectively denote an active power and a reactive power of a storage battery in the i^{th} electric node, p_{wd,i} and Q_{wd,i} respectively denote an active power and a reactive power of a wind generator in the i^{th} electric node, p_{pv,i} and Q_{pv,i} respectively denote an active power and a reactive power of a photovoltaic output of the i^{th} electric node, p_{eb,i} and Q_{eb,i} respectively denote an active power and a reactive power of an electric boiler in the i^{th} electric node, and p_{load,i} and Q_{load,i} respectively denote an active power and a reactive power of an electric load in the i^{th} electric node;
power error equations of the electric nodes are calculated and expressed as:

$$\{ \begin{matrix}Δ {P}_{i} = {P}_{is} - {V}_{i} {\sum }_{j ∈ i} {V}_{j} ( {G}_{ij} cos {θ}_{ij} + {B}_{ij} sin {θ}_{ij} ) \\ Δ {Q}_{i} = {Q}_{is} - {V}_{i} {\sum }_{j ∈ i} {V}_{j} ( {G}_{ij} cos {θ}_{ij} - {B}_{ij} sin {θ}_{ij} )\end{matrix}$$

where, pᵢₛ and Qᵢₛ are an active power and a reactive power set for the i^{th} electric node, Vᵢ and Vⱼ are respectively a voltage injected into the i^{th} electric node and a voltage injected into a j^{th} electric node, and Gᵢⱼ, Bᵢⱼ and θᵢⱼ are respectively a conductance, a susceptance and a phase angle difference between the i^{th} electric node and the j^{th} electric node;
a correction equation simplified based on the Newton-Raphson method is:

$$[ \begin{matrix}Δ P \\ Δ Q\end{matrix} ] = - [ \begin{matrix}\frac{\partial Δ P}{\partial θ} & \frac{\partial Δ P}{\partial V} V \\ \frac{\partial Δ Q}{\partial θ} & \frac{\partial Δ Q}{\partial V} V\end{matrix} ] [ \begin{matrix}Δ θ \\ \frac{Δ V}{V}\end{matrix} ]$$

a phase angle allowance Δθ and a phase angle allowance ΔV of each electric node are calculated according to the correction equation, the phase angle and voltage of each electric node are corrected repeatedly, and when Δpᵢ and ΔQᵢ are both less than ε, correction is stopped, and a final phase angle and a final voltage of each electric node are obtained; ε denotes a permissible error of a power unbalance of the nodes.

Preferably, the electricity selling cost C_{E} is expressed as:

$${C}_{E} = \{ \begin{matrix}{\sum }_{t = 1}^{T} {w}_{pe}^{t} {P}_{e}^{t} , & {P}_{e}^{t} \geq 0 \\ {\sum }_{t = 1}^{T} {w}_{se}^{t} {P}_{e}^{t} , & {P}_{e}^{t} < 0\end{matrix}$$

where, wₚₑ^{t} and wₛₑ^{t} respectively denote an electricity purchase price and an electricity selling price at the time t, and pₑ^{t} denotes electric power for electricity purchase and selling, which is a positive value in a case of electricity purchase and is a negative value in a case of electricity selling.

Preferably, the gas purchase cost C_{GAS} is calculated by:

$${C}_{GAS} = {W}_{gas} {\sum }_{t = 1}^{T} {\sum }_{i = 1}^{{N}_{chp}} {P}_{chp , i}^{t}$$

where, N_{chp} denotes the number of CHP units, w_{gas} denotes a price of unit electric power generated by the CHP units, and p_{chp,i}^{t} denotes electric power generated by an i^{th} CHP unit.

Preferably, the device operating cost C_{OP} is calculated by:

$${C}_{OP} = {\sum }_{i = 1}^{{N}_{wd}} {\sum }_{t = 1}^{T} {O}_{wd} {P}_{wd , i}^{t} + {\sum }_{i = 1}^{{N}_{pw}} {\sum }_{t = 1}^{T} {O}_{pv} {P}_{pv , i}^{t} + {\sum }_{i = 1}^{{N}_{es}} {\sum }_{t = 1}^{T} {O}_{es} {P}_{es , i}^{t} + {\sum }_{i = 1}^{{N}_{chp}} {\sum }_{t = 1}^{T} {O}_{chp} {P}_{chp , i}^{t} + {\sum }_{i = 1}^{{N}_{hs}} {\sum }_{t = 1}^{T} {O}_{hs} {P}_{hs , i}^{h , t} + {\sum }_{i = 1}^{{N}_{eb}} {\sum }_{t = 1}^{T} {O}_{eb} {P}_{eb , i}^{t}$$

where, N_{wd}, Nₚᵥ, Nₑₛ, Nₕₛ and N_{eb} respectively denote the number of wind generation units, the number of photovoltaic generation units, the number of power storage devices, the number of heat storage devices and the number of electric boilers, O_{wd}, Oₚᵥ, Oₑₛ, O_{chp}, Oₕₛ and O_{eb} respectively denote an operating cost coefficient of the wind generation units, an operating cost coefficient of the photovoltaic generation units, an operating cost coefficient of the power storage devices, an operating cost coefficient of the heat storage devices and an operating cost coefficient of the electric boiler, p_{wd,i}^{t}, Oₚᵥ, O_{chp}, Oₑₛ, Oₕₛ and O_{eb} respectively denote electric power generated by the wind generation units, electric power generated by the photovoltaic generation units, electric power generated by the power storage devices and electric power generated by the CHP units, and p_{hs,i}^{h,t} and p_{eb,i}^{t} respectively denote heat power output by the heat storage devices and heat power output by the electric boilers.

Preferably, the wind and photovoltaic power curtailment penalty cost C_{GWP} is calculated by:

$${C}_{GWP} = {\sum }_{i = 1}^{{N}_{wd}} {\sum }_{t}^{T} {α}_{wd} ( {\overline{P}}_{wd \cdot i}^{t} - {P}_{wd \cdot i}^{t} ) + {\sum }_{i = 1}^{{N}_{pv}} {\sum }_{t}^{T} {α}_{pv} ( {\overline{P}}_{pv \cdot i}^{t} - {P}_{pv \cdot i}^{t} )$$

where, α_{wd} and αₚᵥ respectively denote a wind power curtailment penalty cost and a photovoltaic power curtailment penalty cost, and P̅_{wd}^{t} and P̅ₚᵥ^{t} respectively denote a predicted value of wind power and a predicted value of photovoltaic power.

Preferably, the added power network constraints for optimal scheduling comprise an active power balance constraint, an electric node voltage constraint, a branch transmission power constraint and a branch power loss constraint of a power network, and the added heat network constraints comprise a power balance constraint and a pipe heat loss constraint of a heat network.

Preferably, a method for iterating and updating the weights and thresholds in the BP neural network by means of the SA-PSO algorithm to obtain the SA-PSO-BP neural network comprise:
initializing the weights and thresholds in the BP neural network; taking lengths of the weights and thresholds in the BP neural network as dimensions of a particle swarm, taking the weights and thresholds as positions of particles, and initializing a weight w, learning rates c₁ and c₂, a position X and a speed v of the particle swarm and a temperature T and annealing coefficient K of simulated annealing;
taking a prediction error in the training process of the neural network as a fitness F of the particle swarm, applying a stochastic disturbance to the particles to obtain new particles x_{new}, and if a new fitness Fₓ_{_{new}} is less than or equal to an existing fitness Fₓ, using the new fitness Fₓ_{_{new}} as an optimal fitness;
if Fₓ_{_{new}}>Fₓ and exp (−(F−F)/TK)≤rand ( ), using the new fitness Fₓ_{_{new}} as the optimal fitness; if Fₓ_{_{new}}>Fₓ and exp (−(F− F)/TK)≤rand ( ), using the existing fitness Fₓ as the optimal fitness, wherein exp ( ) denotes an exponent operation with a natural logarithm e as a base, and rand( ) denotes a random function for generating random numbers; and
iterating and updating the weight w, the learning rates c₁ and c₂, the position x and the speed V of the particle swarm and the fitness F of the particle swarm; when the number of iterations reaches a preset value, outputting a global optimal solution F_{g} and a corresponding BP neural network, and taking the trained BP neural network as the SA-PSO-BP neural network.

Compared with the prior art, the invention has the following beneficial effects:
According to the invention, correlated features of wind generation power, photovoltaic power, and electric-thermal loads in an integrated energy system are acquired, the correlated features are preprocessed and screened to obtain preferred features, a feature training set is constructed, a BP neural network is trained by means of the feature training set, renewable energy and multivariate loads in the integrated energy system are predicted by means of a pretrained SA-PSO-BP neural network, and the integrated energy system is controlled according to prediction results of the renewable energy and the multivariate loads, such that the operating safety and stability of the integrated energy system are improved.
According to the invention, an objective function of the integrated energy system is constructed, power network constraints and heat network constraints for optimal scheduling are added, an optimal solution of the objective function is obtained by means of a SA-PSO-BP neural network based on prediction results of the renewable energy and the multivariate loads, and the integrated energy system is controlled according to the optimal solution of the objective function, such that both the safety and economy of the integrated energy system are guaranteed.

### BRIEF DESCRIPTION OF THE DRAWINGS

FIG. 1 is a flow diagram of an electric-thermal integrated energy control method based on safety and economy according to one embodiment of the invention;

FIG. 2 is a flow diagram of predicting renewable energy and multivariate loads based on an SA-PSO-BP neural network;

FIG. 3 is a topological diagram of a safe and economical integrated design method for an electric-thermal integrated energy system;

FIG. 4 is a flow diagram of solving an objective function based on SA-PSO algorithm;

FIG. 5 is a diagram of renewable energy and the multivariate loads predicted based on an SA-PSO-BP neural network;

FIG. 6 is a diagram of power network scheduling based on a safe and economical integrated method;

FIG. 7 is a diagram of heat network scheduling based on the safe and economical integrated method;

FIG. 8 is a diagram of voltages of electric nodes of a system based on the safe and economical integrated method.

### DETAILED DESCRIPTION

The invention is further described below in conjunction with accompanying drawings. The following embodiments are merely used to more clearly explain the technical solution of the invention and should not be construed as limitations of the protection scope of the invention.

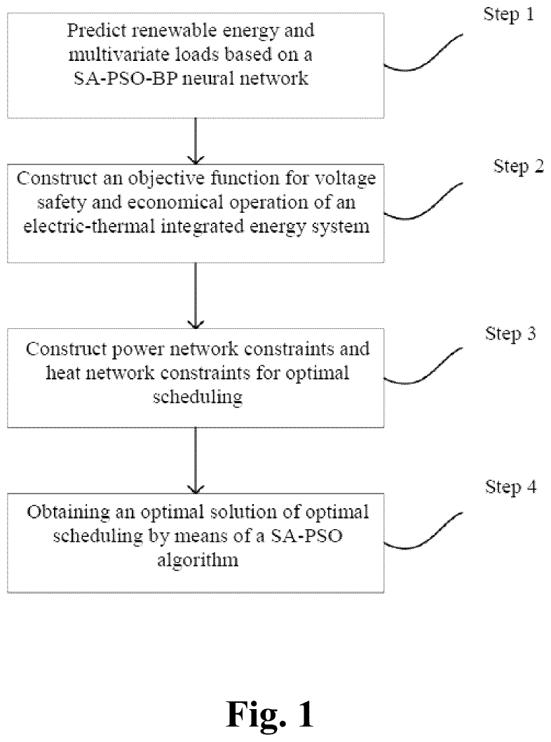

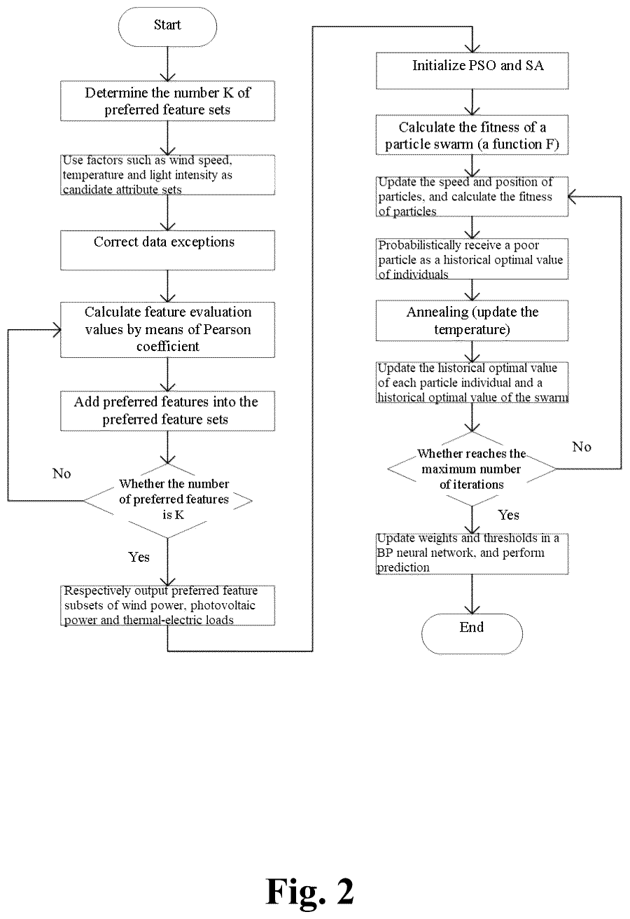

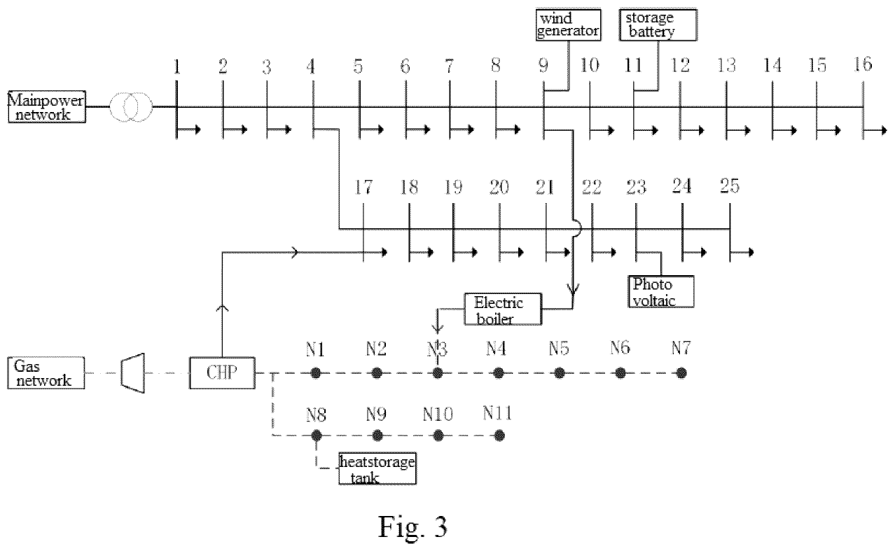

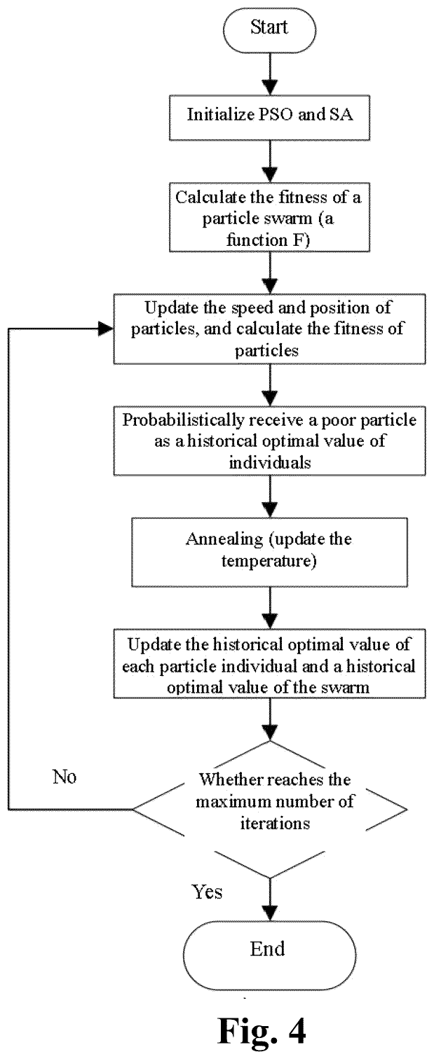

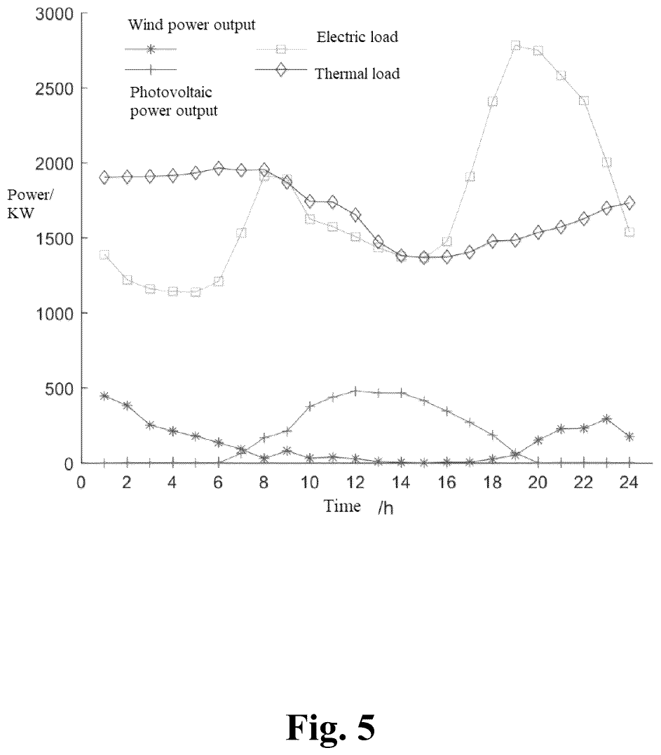

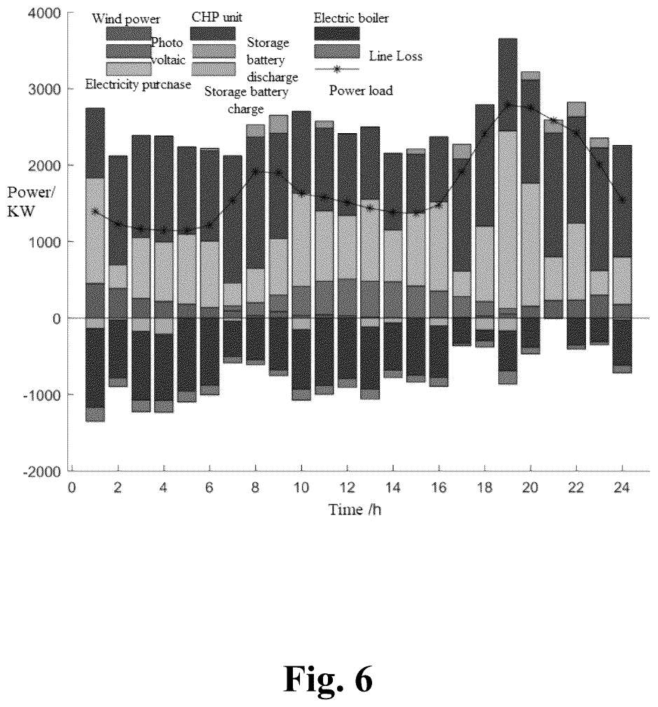

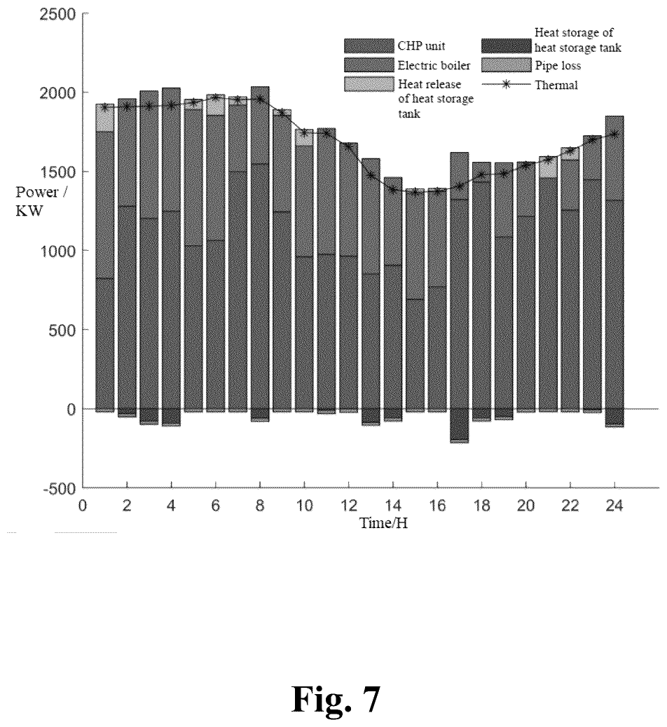

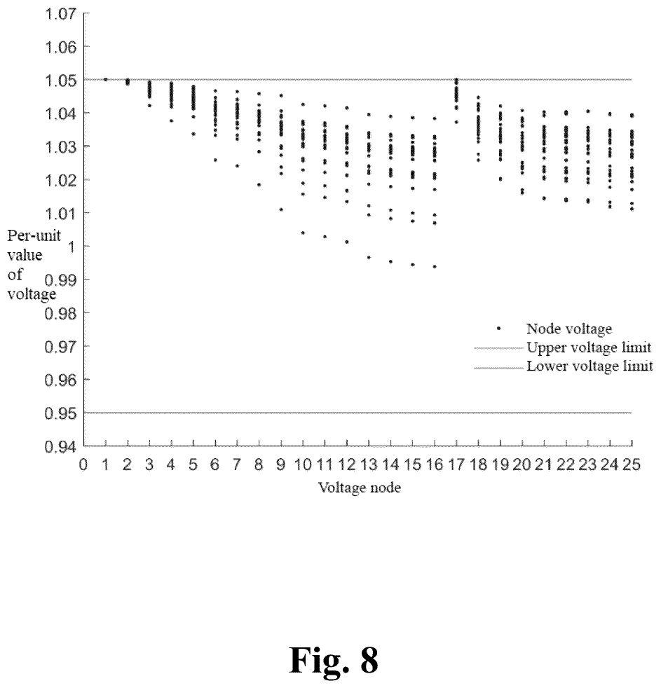

As shown in FIGS. 1-8, an electric-thermal integrated energy control method based on safety and economy comprises:
training a SA-PSO-BP neural network, which comprises:
determining a topological structure of a BP neural network according to preferred features and an output power of an integrated energy system;
acquiring correlated features of wind power, photovoltaic power and electric-thermal loads in the integrated energy system, preprocessing and screening the correlated features to obtain preferred features, and constructing a feature training set; and
a method for preprocessing the correlated features comprising:
eliminating abnormal data from the correlated features of the wind power, the photovoltaic power and the electric-thermal loads based on a 3δ principle respectively according to the following formulas:

$${\overline{p}}_{i} = \frac{{{\sum }_{i = 1}}^{n} {p}_{i}}{n} \\ δ = \sqrt{\frac{1}{n - 1} {\sum }_{i = 1}^{n} {( {p}_{i} - \overline{p} )}^{2}} \\ {p}_{e} = \vert {p}_{i} - \overline{p} \vert$$

where, pᵢ denotes an i^{th} sample value of a same feature, p̅ᵢ denotes a sample mean, δ denotes a reference standard value, n is the number of samples, and pₑ is a residual error; when the residual error pₑ of one correlated feature is greater than 3δ, the correlated feature will be eliminated; and
filling the correlated features of the wind power, the photovoltaic power and the electric-thermal loads with missing data by means of a Lagrange interpolation method according to the following formula:

$$L ( x ) = {\sum }_{i = 0}^{n} {y}_{i} {\prod }_{j = 0 , j \neq i}^{n} \frac{x - {x}_{i}}{{x}_{i} - {x}_{j}}$$

where, xᵢ denotes a time of a (i+1)^{th} value point, yᵢ indicates a feature value of the (i+1)^{th} value point, xⱼ denotes a feature value of a j^{th} value point, and L(x) denotes a feature interpolation corresponding to a given time x;
a method for screening the correlated features to obtain preferred features comprising:
estimating a correlation between the correlated features by means of a Pearson correlation coefficient according to the following formula:

$${ρ}_{X Y} = \frac{Cov ( X , Y )}{{σ}_{X} {σ}_{Y}}$$

where, X denotes a feature value vector, Y denotes an actual value vector required by the wind power, the photovoltaic power, the electric loads or the thermal loads, and ρ_{XY} denotes a correlation degree between X and Y; C ov(X, Y) denotes a covariance of X and Y, and σ_{X} and σ_{Y} respectively denote a standard deviation of X and a standard deviation of Y; and screening the preferred features from the correlated features of the wind power, the photovoltaic power and the electric-thermal loads according to the correlation degree; and
training the BP neural network by means of the feature training set, and iterating and updating weights and thresholds in the BP neural network in the training process by means of a SA-PSO algorithm to obtain the SA-PSO-BP neural network, which specifically comprises:
initializing weights and thresholds in the BP neural network; taking lengths of the weights and thresholds in the BP neural network as dimensions of a particle swarm, taking the weights and thresholds as positions of particles, and initializing a weight w, learning rates c₁ and c₂, a position x and a speed v of the particle swarm and a temperature T and annealing coefficient K of simulated annealing;
taking a prediction error in the training process of the neural network as a fitness F of the particle swarm, applying a stochastic disturbance to the particles to obtain new particles x_{new}, and if a new fitness Fₓ_{_{new}} is less than or equal to an existing fitness Fₓ, using the new fitness Fₓ_{_{new}} as an optimal fitness;
if Fₓ_{_{new}}>Fₓ and exp (−(F−F)/TK)≤rand ( ), using the new fitness Fₓ_{_{new}} as the optimal fitness; if Fₓ_{_{new}}>Fₓ and exp (−F(f−F)/TK)≤rand ( ), using the existing fitness Fₓ as the optimal fitness, wherein exp ( ) denotes an exponent operation with a natural logarithm e as a base, and rand ( ) denotes a random function for generating random numbers; and
iterating and updating the weight w, the learning rates c₁ and c₂ the position X and the speed v of the particle swarm and the fitness F of the particle swarm; when the number of iterations reaches a preset value, outputting a global optimal solution F_{g} and a corresponding BP neural network, and taking the trained BP neural network as the SA-PSO-BP neural network;
predicting renewable energy and multivariate loads in the integrated energy system based on the pretrained SA-PSO-BP neural network;
normalizing the sum f₁ of absolute deviations of node voltages of the integrated energy system at different times into F₁;
integrating an electricity selling cost C_{E}, a gas purchase cost C_{GAS} a device operating cost C_{OP} and a wind and photovoltaic power curtailment penalty cost C_{GWP} into an economic cost f₂, and normalizing f₂ into F₂;
constructing an objective function of the integrated energy system, and adding power network constraints and heat network constraints for optimal scheduling;
wherein, a formula for constructing the objective function is:

$$\{ \begin{matrix}F = min ( {λ}_{1} {F}_{1} + {λ}_{2} {F}_{2} ) \\ {F}_{1} = \frac{{f}_{1}}{{f}_{1}^{max}} \\ {F}_{2} = \frac{{f}_{2}}{{f}_{2}^{max}} \\ {f}_{1} = {\sum }_{i = 1}^{{N}_{V}} {\sum }_{t = 1}^{T} \vert {\tilde{V}}_{i , B} \vert \\ {f}_{2} = {C}_{E} + {C}_{G A S} + {C}_{O P} + {C}_{G W P}\end{matrix}$$

where, λ₁ and λ₂ are respectively weights of F₁ and F₂, f₁^{max} is a maximum value of the sum of the absolute deviations of the node voltages of the integrated energy system, f₂^{max} is a maximum power output cost of devices in the integrated energy system, T is a total operating time of the integrated energy system, N_{V} is the number of electric nodes, and \tilde{V}_{i,B}^{t} is a difference between the voltage of an i^{th} electric node at a time t and a safety margin.

The difference \tilde{V}_{i,B}^{t} between the voltage of the i^{th} electric node at the time t and the safety margin is calculated by:

$${\tilde{V}}_{i , B}^{t} = \{ \begin{matrix}{V}_{i , B}^{t} - {V}_{min} & , {V}_{i , B}^{t} < {V}_{min} \\ 0 & , {V}_{min} \leq {V}_{i , B}^{t} \leq {V}_{max} \\ {V}_{i , B}^{t} - {V}_{max} & , {V}_{i , B}^{t} > {V}_{max}\end{matrix}$$

where, V_{i,B}^{t} denotes a per-unit value of the voltage of the i^{th} electric node at the time t, Vₘₐₓ denotes an upper limit of the per-unit value of the node voltage, and Vₘᵢₙ denotes a lower limit of the per-unit value of the node voltage.

Under the influence of a heat network, the per-unit value V_{i,B}^{t} of the voltage of i^{th} electric node is corrected by means of a Newton-Raphson method as follows:
relative injected powers of the electric nodes are expressed as:

$$\{ \begin{matrix}{P}_{i} = {P}_{chp , i} + {P}_{es , i} + {P}_{wd , i} + {P}_{pv , i} - {P}_{eb , i} - {P}_{load , i} \\ {Q}_{i} = {Q}_{chp , i} + {Q}_{es , i} + {Q}_{wd , i} + {Q}_{pv , i} - {Q}_{eb , i} - {Q}_{load , i}\end{matrix}$$

where, Pᵢ and Qᵢ respectively denote an active power and a reactive power injected into the i^{th} electric node, P_{chp,i} and Q_{chp,i} respectively denote an active power and a reactive power of a CHP unit in the i^{th} electric node, P_{es,i} and Q_{es,i} respectively denote an active power and a reactive power of a storage battery in the i^{th} electric node, P_{wd,i} and Q_{wd,i} respectively denote an active power and a reactive power of a wind generator in the i^{th} electric node, P_{pv,i} and Q_{pv,i} respectively denote an active power and a reactive power of a photovoltaic output of the i^{th} electric node, P_{eb,i} and Q_{eb,i} respectively denote an active power and a reactive power of an electric boiler in the i^{th} electric node, and P_{load,i} and Q_{load,i} respectively denote an active power and a reactive power of an electric load in the i^{th} electric node;
power error equations of the electric nodes are calculated and expressed as:

$$\{ \begin{matrix}Δ {P}_{i} = {P}_{is} - {V}_{i} {\sum }_{j ∈ i} {V}_{j} ( {G}_{ij} cos {θ}_{ij} + {B}_{ij} sin {θ}_{ij} ) \\ Δ {Q}_{i} = {Q}_{is} - {V}_{i} {\sum }_{j ∈ i} {V}_{j} ( {G}_{ij} cos {θ}_{ij} - {B}_{ij} sin {θ}_{ij} )\end{matrix}$$

where, Pᵢₛ and Qᵢₛ are an active power and a reactive power set for the i^{th} electric node, Vᵢ and Vⱼ are respectively a voltage injected into the i^{th} electric node and a voltage injected into a j^{th} electric node, and Gᵢⱼ, Bᵢⱼ and θᵢⱼ are respectively a conductance, a susceptance and a phase angle difference between the i^{th} electric node and the j^{th} electric node;
a correction equation simplified based on the Newton-Raphson method is:

$$[ \begin{matrix}Δ P \\ Δ Q\end{matrix} ] = [ \begin{matrix}\frac{\partial Δ P}{\partial θ} & \frac{\partial Δ P}{\partial V} V \\ \frac{\partial Δ Q}{\partial θ} & \frac{\partial Δ Q}{\partial V} V\end{matrix} ] [ \begin{matrix}Δθ \\ \frac{Δ V}{V}\end{matrix} ]$$

a phase angle allowance Δθ and a phase angle allowance ΔV of each electric node are calculated according to the correction equation, the phase angle and voltage of each electric node are corrected repeatedly, and when ΔPᵢ and ΔQᵢ are both less than ε, correction is stopped, and a final phase angle and a final voltage of each electric node are obtained; ε denotes a permissible error of a power unbalance of the nodes.

The electricity selling cost C_{E} is expressed as:

$${C}_{E} = \{ \begin{matrix}{\sum }_{t = 1}^{T} {w}_{pe}^{t} {P}_{e}^{t} , {P}_{e}^{t} \geq 0 \\ {\sum }_{t = 1}^{T} {w}_{se}^{t} {P}_{e}^{t} , {P}_{e}^{t} < 0\end{matrix}$$

where, wₚₑ^{t} respectively denote an electricity purchase price and an electricity selling price at the time t, and Pₑ^{t} denotes electric power for electricity purchase and selling, which is a positive value in a case of electricity purchase and is a negative value in a case of electricity selling.

The gas purchase cost C_{GAS} is calculated by:

$${C}_{G A S} = {w}_{gas} {\sum }_{t = 1}^{T} {\sum }_{i = 1}^{{N}_{chp}} {P}_{chp , i}^{t}$$

where, N_{chp} denotes the number of CHP units, w_{gas} denotes a price of unit electric power generated by the CHP units, and P_{chp,i}^{t} denotes electric power generated by an i^{th} CHP unit.

The device operating cost C_{OP} is calculated by:

$${C}_{O P} = {\sum }_{i = 1}^{{N}_{w d}} {\sum }_{t = 1}^{T} {O}_{w d} {P}_{wd , i}^{t} + {\sum }_{i = 1}^{{N}_{pv}} {\sum }_{t = 1}^{T} {O}_{p v} {P}_{pv , i}^{t} + {\sum }_{i = 1}^{{N}_{es}} {\sum }_{t = 1}^{T} {O}_{e s} {P}_{es , i}^{t} + {\sum }_{i = 1}^{{N}_{chp}} {\sum }_{t = 1}^{T} {O}_{chp} {P}_{chp , i}^{t} + {\sum }_{i = 1}^{{N}_{hs}} {\sum }_{t = 1}^{T} {O}_{hs} {P}_{hs , i}^{h , t} + {\sum }_{i = 1}^{{N}_{eb}} {\sum }_{t = 1}^{T} {O}_{e s} {P}_{eb , i}^{t}$$

where, N_{wd}, Nₚᵥ, Nₑₛ, Nₕₛ and N_{eb} respectively denote the number of wind generation units, the number of photovoltaic generation units, the number of power storage devices, the number of heat storage devices and the number of electric boilers, O_{wd}, Oₚᵥ, Oₑₛ, O_{chp}, Oₕₛ and O_{eb} respectively denote an operating cost coefficient of the wind generation units, an operating cost coefficient of the photovoltaic generation units, an operating cost coefficient of the power storage devices, an operating cost coefficient of the heat storage devices and an operating cost coefficient of the electric boiler, P_{wd,i}^{t}, P_{pv,i}^{t}, P_{es,i}^{t} and P_{chp,i}^{t} respectively denote electric power generated by the wind generation units, electric power generated by the photovoltaic generation units, electric power generated by the power storage devices and electric power generated by the CHP units, and P_{hs,i}^{h,t} and P_{eb,i}^{t} respectively denote heat power output by the heat storage devices and heat power output by the electric boilers;
The wind and photovoltaic power curtailment penalty cost C_{GWP} is calculated by:

$${C}_{GWP} = {\sum }_{i = 1}^{{N}_{wd}} {{\sum }_{t}}^{T} {α}_{wd} ( {\overline{P}}_{wd \cdot i}^{t} - {P}_{wd \cdot i}^{t} ) + {\sum }_{i = 1}^{{N}_{pv}} {\sum }_{t}^{T} {α}_{pv} ( {\overline{P}}_{pv \cdot i}^{t} - {P}_{pv \cdot i}^{t} )$$

where, α_{wd} and αₚᵥ respectively denote a wind power curtailment penalty cost and a photovoltaic power curtailment penalty cost, and P̅_{wd}^{t} and P̅ₚᵥ^{t} respectively denote a predicted value of wind power and a predicted value of photovoltaic power.

The power network constraints and the heat network constraints for optimal scheduling are added for the objective function, wherein the added power network constraints for optimal scheduling comprise an active power balance constraint, an electric node voltage constraint, a branch transmission power constraint a branch power loss constraint and other constraints of a power network;
(1) The active balance constraint of the power network is expressed as:

$${\sum }_{i = 1}^{{N}_{w d}} {P}_{wd , i}^{t} + {\sum }_{i = 1}^{{N}_{pv}} {P}_{pv , i}^{t} + {\sum }_{i = 1}^{{N}_{chp}} {P}_{chp , i}^{t} - {\sum }_{i = 1}^{{N}_{es}} ( {P}_{es , c}^{t} {η}_{c} - {P}_{es , d}^{t} / {η}_{d} ) - {\sum }_{i = 1}^{{N}_{eb}} {P}_{eb , i}^{t} + {P}_{e , i}^{t} - {\sum }_{i = 1}^{{N}_{line}} {P}_{line , i}^{t} = {\sum }_{i = 1}^{{N}_{el}} {P}_{el , i}^{t}$$

where, N_{eb} and Nₑₗ respectively denote the number of the electric boilers and the number of the electric loads, P_{es,c}^{t}, and P_{es,d}^{t} respectively denote a charge power and a discharge power of the power storage devices, η_{c} and η_{d} respectively denote charge efficiency and discharge efficiency, P_{eb,i}^{t} denotes electric power consumed by the electric boilers, P_{el,i}^{t} denotes electric power consumed by the electric loads, and P_{line,i}^{t} denotes the power loss of the i^{th} branch at a time t.

### (2) Branch Transmission Power Constraint

To ensure that the voltages of the electric nodes of the system will not exceed the safety margin, in this embodiment, the value of a safety weight λ₁ is set to be far greater than the value of a cost weight λ₂, that is, the voltage is economically scheduled within a safety range [Vₘᵢₙ, Vₘₐₓ].

### (3) Branch Power Loss Constraint of the Power Network

$${P}_{l , i}^{min} \leq \vert {P}_{l}^{t} \vert = \vert {P}_{ij}^{t} \vert = \vert {V}_{i}^{t} {V}_{j}^{t} ( {G}_{ij} cos {θ}_{ij} + {B}_{ij} sin {θ}_{ij} ) - {V}_{i}^{2} {G}_{ij} \vert \leq {P}_{l , i}^{max}$$

where, P_{l,i}^{min} and P_{l,i}^{max} respectively denote a minimum value and a minimum value of an active power flow of an lₜₕ branch, Pₗ^{t} denotes the active power flow of the l^{th} branch, Pᵢⱼ^{t} denotes a power of a line between the i^{th} node and the j^{th} node, Gᵢⱼ and Bᵢⱼ respectively denote a real part and an imaginary part of an element in an i^{th} row and a^{th} column of a node admittance matrix, θᵢ denotes a voltage phase of the i^{th} node, and θᵢⱼ denotes a voltage phase difference between θᵢ and θⱼ.

### (4) Branch Power Loss Constraint of the Power Network

$${P}_{line , i}^{t} = \frac{{P}_{i}^{{t}^{2}} + {Q}_{i}^{{t}^{2}}}{{U}_{0}^{2}} {R}_{i}$$

where, Pᵢ^{t} and Qᵢ^{t} respectively denote an active power and a reactive power injected into the i^{th} electric node, and U₀ and Rᵢ respectively denote a reference voltage of the system and a resistance of a branch connected to the i^{th} electric node.

### (5) Other Constraints of the Power Network

$$\{ \begin{matrix}{P}_{wd , i}^{max} \leq {P}_{wd , i}^{t} \leq {P}_{wd , i}^{max} \\ {P}_{pv , i}^{max} \leq {P}_{pv , i}^{t} \leq {P}_{pv , i}^{max} \\ {P}_{chp , i}^{max} \leq {P}_{chp , i}^{t} \leq {P}_{chp , i}^{max} \\ {S}_{chp , i}^{max} \leq {P}_{chp , i}^{t} - {P}_{chp , i}^{t - 1} \leq {S}_{chp , i}^{max} \\ {E}_{e s}^{t} = ( 1 - {α}_{e s} ) {E}_{e s}^{t - 1} + [ {P}_{es , c}^{t} {η}_{c} - \frac{{P}_{es , d}^{t}}{{η}_{d}} ] \\ {E}_{e s}^{min} < {E}_{e s}^{t} < {E}_{e s}^{max} \\ {P}_{es , c}^{min} \leq {P}_{es , c}^{t} \leq {P}_{es , c}^{max} \\ {P}_{es , d}^{min} \leq {P}_{es , d}^{t} \leq {P}_{es , d}^{max} \\ {E}_{e s}^{{T}_{0}} = {E}_{e s}^{T} \\ {P}_{e b}^{min} \leq {P}_{eb , i}^{t} \leq {P}_{e b}^{max} \\ {P}_{e b}^{h , t} = {β}_{e b} {P}_{e b}^{t} \\ {P}_{e}^{min} < {P}_{e}^{t} < {P}_{e}^{max}\end{matrix}$$

where, P_{wd,i}^{max} and P_{wd,i}^{max} respectively denote an upper limit and a lower limit of a power output of the wind generation units, P_{pv,i}^{max} and P_{pv,i}^{max} respectively denote an upper limit and a lower limit of a power output of the photovoltaic generation units, P_{chp,i}^{max} and P_{chp,i}^{max} respectively denote an upper limit and a lower limit of a power output of the CHP units, S_{chp,i}^{max} and S_{chp,i}^{max} respectively denote an upper climbing limit and a lower climbing limit the CHP units, Eₑₛ^{t} denotes a power storage capacity, P_{es,d}^{t} denotes a heat loss rate of a heat storage tank, P_{es,c}^{t} and P_{es,d}^{t} respectively denote a charge power and a discharge power, η_{c} and η_{d} respectively denote charge efficiency and discharge efficiency, Eₑₛ^{min} and Eₑₛ^{max} respectively denote an upper limit and a lower limit of the power storage capacity, P_{es,c}^{min} and P_{es,c}^{max} respectively denote an upper limit and a lower limit of the charge power, P_{es,d}^{min} and P_{es,c}^{max} respectively denote an upper limit and a lower limit of the discharge power, P_{es,d}^{min} and P_{es,d}^{max} respectively denote an initial power storage capacity and a power storage capacity after a period of the storage batteries, indicating that the capacity of the storage batteries returns to the initial state after one period during scheduling, P_{eb}^{min} and P_{eb}^{max} respectively denote an upper limit and a lower limit of electric power consumed by the electric boilers, β^{eb} denotes an electric-thermal coefficient of the electric boilers, and Pₑ^{max} and Pₑ^{min} respectively denote an upper limit and a lower limit of electricity purchase and selling.

The added heat network constraints comprise a power balance constraint, a pipe heat loss constraint and other constraints of a heat network;

(1) Power balance constraint of a thermal network

$${\sum }_{i = 1}^{{N}_{chp}} {P}_{chp , i}^{h , t} + {\sum }_{i = 1}^{{N}_{eb}} {P}_{eb , i}^{h , t} - {\sum }_{i = 1}^{{N}_{hs}} ( {β}_{c}^{h} {P}_{hs , c}^{h , t} - {P}_{hs , d}^{h , t} / {β}_{d}^{h} ) - {\sum }_{i = 1}^{{N}_{pip}} {P}_{pip , i}^{h , t} = {\sum }_{i = 1}^{{N}_{hl}} {P}_{hl , i}^{h , t}$$

where, Nₕₗ denotes the number of thermal loads, Nₚᵢₚ denotes the number of branches of the heat network, P_{chp,i}^{h,t} and P_{eb,i}^{h,t} respectively denote a heat power generated by the CHP units and a heat power generated by the electric boilers, β_{c}^{h} and β_{d}^{h} respectively denote a heat storage state and a heat release state, P_{hs,c}^{h,t} and P_{hs,d}^{h,t} respectively denote a heat storage power and a heat release power, and P_{pip,i}^{h,t} denotes heat dissipation of an i^{th} branch of the heat network at the time t.

### (2) Pipe Heat Loss Constraint of the Heat Network

$${Q}_{loss , i}^{t} = \frac{{l}_{i} ( {T}_{i , t} - {T}_{0} )}{{R}_{1} + {R}_{2}}$$

where, Q_{loss,i}^{t} denotes a heat loss power of an i^{th} pipe of the heat network, lᵢ denotes the length of the i^{th} pipe of the heat network, T_{i,t} is the temperature of hot water in pipes, T₀ is an ambient temperature outside the pipes, R₁ denotes a heat resistance of the pipes of the heat network, and R₂ denotes a heat resistance of a heat insulation layer of the pipes.
   (3) Other constraints of the heat network

$$\{ \begin{matrix}{P}_{chp , i}^{h , t} = {β}_{chp} {P}_{chp , i}^{t} \\ {w}_{gas} = {C}_{c {h}_{4}} \frac{{P}_{c h p}^{t}}{{L}_{n g} {η}_{c h p}} Δ t \\ {P}_{e b}^{h , t} = {β}_{e b} ( 1 - {α}_{e b} ) {P}_{e b}^{t} \\ {Q}_{h s}^{t} = ( 1 - {α}_{h s} ) {Q}_{h s}^{t - 1} + [ {β}_{c}^{h} {P}_{hs , c}^{h t} - \frac{{P}_{hs , d}^{h , t}}{{β}_{d}^{h}} ] \\ {Q}_{h s}^{min} < {Q}_{h s}^{t} < {Q}_{h s}^{max} \\ {P}_{hs , c}^{min} \leq {P}_{hs , c}^{h , t} \leq {P}_{hs , c}^{max} \\ {P}_{hs , d}^{min} \leq {P}_{hs , d}^{h , t} \leq {P}_{hs , d}^{max} \\ {Q}_{h s}^{{T}_{0}} = {Q}_{h s}^{T}\end{matrix}$$

where, β_{chp} denotes a thermal-electric ratio coefficient, C_{ch}_{₄} denotes the price of natural gas, P_{chp}^{t} denotes electric power output by the CHP units, L^{ng} denotes a low heat value of natural gas, η^{chp} denotes power generation efficiency of the CHP units, Δt denotes a unit scheduling time, β_{eb} denotes a thermal-electric ratio coefficient of the electric boilers, α_{eb} denotes a heat loss rate of the electric boilers, Qₕₛ^{t} denotes a heat storage capacity, αₕₛ denotes a heat loss rate, and respectively denote heat storage efficiency and heat release efficiency, P_{hs,c}^{h,t} and P_{hs,d}^{h,t} respectively denote a heat storage power and a heat release power, Qₕₛ^{min} and Qₕₛ^{max} respectively denote an upper limit and a lower limit of the heat storage capacity, P_{hs,c}^{min} and P_{hs,c}^{max} respectively denote an upper limit and a lower limit of the heat storage power, Qₕₛ^{T}^{₀} and Qₕₛ^{T} respectively denote an intimal state of charge of the storage batteries and a state of charge of the storage batteries after one period, indicating that the storage batteries return to the initial state after one period during scheduling.

A method for obtaining an optimal solution of the objective function by means of a SA-PSO algorithm based on prediction results of the renewable energy and the multivariate loads comprises:
initializing parameters, wherein the size of a particle swarm is 40, a maximum number Dₘₐₓ of iterations is 800, weights wₘₐₓ and wₘᵢₙ of the particle swarm are respectively 1 and 0.5, learning factors cₘₐₓ and cₘᵢₙ are respectively 2.5 and 0.5, an initial temperature T is 100, and an annealing coefficient k is 0.96;
updating the weight w, the learning rates c₁ and c₂, the position X and the speed v of the particles and the fitness F of the particles according to the following formulas:

$$\{ \begin{matrix}w = {w}_{max} - ( {w}_{max} - {w}_{min} ) \frac{d}{{D}_{max}} \\ {c}_{1} = {c}_{max} - ( {c}_{min} - {c}_{max} ) \frac{d}{{D}_{max}} \\ {c}_{2} = {c}_{min} - ( {c}_{max} - {c}_{min} ) \frac{t}{{D}_{max}} \\ {V}_{i}^{k + 1} = {wV}_{i}^{k} + {c}_{1} \times r {d}_{1} \times ( {pb}_{i}^{k} - {X}_{i}^{k} ) + {c}_{2} \times r {d}_{2} \times ( g {b}^{k} - {X}_{i}^{k} ) \\ {X}_{i}^{k + 1} = {X}_{i}^{k} + {V}_{i}^{k + 1}\end{matrix}$$

where, d is a current number of iterations, D^{mx} is a maximum number of iterations, wₘₐₓ and wₘᵢₙ are adjustment factors of the weight, where cₘₐₓ and cₘᵢₙ are adjustment factors of the learning factors, Vᵢ^{k} and Xᵢ^{k} respectively denote the speed and position of an i^{th} particle in a k^{th} iteration, pbᵢ^{k} and gb^{k} respectively denote a historical optimal position of the i^{th} particle and a historical optimal experience of the swarm in the k^{th} iteration, w is the weight of the particle swarm, and rd₁ and rd₂ are random numbers between 0 and 1;
taking the objective function F as a fitness of the particles, calculating a fitness of the particle swarm, and comparing the fitness of the particles and fitness of the particle swarm to obtain a global initial optimal solution;
applying a stochastic disturbance to the particles to obtain new particles x_{new}, and if Fₓ_{_{new}}≤Fₓ, using Fₓ_{_{new}} as an optimal value of each individual; if Fₓ_{_{new}}>Fₓ, determining whether exp(−(Fₓ_{_{new}}−Fₓ)/TK)>rand( ); if so, using Fₓ_{_{new}} as the optimal value of each individual; otherwise, not using Fₓ_{_{new}} as the optimal value of each individual; and

performing annealing according to T=Tk, updating a historical optimal value Fₚ of each particle individual and a historical optimal value F_{g} of the particle swarm, and controlling the integrated energy system according to the optimal solution of the objective function.

Those skilled in the art should understand that the embodiments of the application can be provided as a method, a system or a computer program product. So, the embodiments of the application may be completely hardware embodiments, completely software embodiments, or embodiments combining software and hardware. In addition, the application may be in the form of a computer program product to be implemented on one or more computer-available storage media (including, but not limited to, a disk memory, a CD-ROM, an optical memory, and the like) comprising computer-available program codes.

The application is described with reference to the flow diagram and/or block diagram of the method, device (system) and computer program product provided by the embodiments of the application. It should be understood that each process and/or block in the flow diagram and/or block diagram and the combinations of processes and/or blocks in the flow diagram and/or block diagram can be implemented by computer program instructions. These computer program instructions can be configured in a general-purpose computer, a special-purpose computer, an embedded processor, or a processor of other programmable data processing equipment to create a machine, so that the instructions can be executed by the computer or the processor of other programmable data processing equipment to create a device for realizing specific functions in one or more processes in the flow diagram and/or in one or more blocks in the block diagram.

These computer program instructions may also be stored in a computer-readable memory that can guide the computer or other programmable data processing equipment to work in a specific manner, so that the instructions stored in the computer-readable memory can create a product including an instruction device, and the instruction device implements specific functions in one or more processes of the flow diagram and/or one or more blocks in the block diagram.

These computer program instructions may also be loaded on a computer or other programmable data processing equipment, so that the computer or other programmable equipment can perform a series of operation steps to carry out processing realized by the computer, and the instructions are executed on the computer or other programmable equipment to realize specific functions in one or more processes in the flow diagram and/or one or more block diagrams in the block diagram.

The above embodiments are merely preferred ones of the invention. It should be noted that various improvements and transformations can be made without departing from the technical principle of the invention, and all these improvements and transformations should also fall within the protection scope of the invention.

1. A control method for an electric-thermal integrated energy system, comprising:
predicting renewable energy and multivariate loads in an integrated energy system based on a pretrained SA-PSO-BP neural network;
constructing an objective function of the integrated energy system, and adding power network constraints and heat network constraints for optimal scheduling; and
obtaining an optimal solution of the objective function by means of a SA-PSO algorithm based on prediction results of the renewable energy and the multivariate loads, and controlling the integrated energy system according to the optimal solution of the objective function;
wherein, a training process of the SA-PSO-BP neural network comprises:
determining a topological structure of a BP neural network according to preferred features and an output power of the integrated energy system; acquiring correlated features of wind power, photovoltaic power and electric-thermal loads in the integrated energy system, preprocessing and screening the correlated features to obtain preferred features, and constructing a feature training set; and
training the BP neural network by means of the feature training set, and iterating and updating weights and thresholds in the BP neural network in the training process by means of the SA-PSO algorithm to obtain the SA-PSO-BP neural network.

2. The control method for an electric-thermal integrated energy system according to claim 1, wherein a method for preprocessing the correlated features comprises:
eliminating abnormal data from the correlated features of the wind power, the photovoltaic power and the electric-thermal loads based on a 38 principle respectively according to the following formulas:
$${\overline{p}}_{i} = \frac{{{\sum }_{i = 1}}^{n} {p}_{i}}{n}$$
$$δ = \sqrt{\frac{1}{n - 1} {\sum }_{i = 1}^{n} {( {p}_{i} - \overline{p} )}^{2}}$$
$${p}_{e} = \vert {p}_{i} - \overline{p} \vert$$
where, pᵢ denotes an i^{th} sample value of a same feature, p̅ᵢ denotes a sample mean, δ denotes a reference standard value, n is the number of samples, and Pₑ a residual error; when the residual error Pₑ of one correlated feature is greater than 3δ, the correlated feature will be eliminated; and
filling the correlated features of the wind power, the photovoltaic power and the electric-thermal loads with missing data by means of a Lagrange interpolation method according to the following formula:
$$L ( x ) = {\sum }_{i = 0}^{n} {y}_{i} {\prod }_{j = 0 , j \neq i}^{n} \frac{x - {x}_{i}}{{x}_{i} - {x}_{j}}$$
where, xᵢ denotes a time of a (i+1)^{th} value point, yᵢ indicates a feature value of the (i+1)^{th} value point, xⱼ denotes a feature value of a j^{th} value point, and L(x) denotes a feature interpolation corresponding to a given time x.

3. The control method for an electric-thermal integrated energy system according to claim 2, wherein a method for screening the correlated features to obtain preferred features comprises:
estimating a correlation between the correlated features by means of a Pearson correlation coefficient according to the following formula:
$${ρ}_{X Y} = \frac{Cov ( X , Y )}{{σ}_{X} {σ}_{Y}}$$
where, X denotes a feature value vector, Y denotes an actual value vector required by the wind power, the photovoltaic power, the electric loads or the thermal loads, and ρ_{XY} denotes a correlation degree between X and Y; C ov(X,Y) denotes a covariance of X and Y, and σ_{X} and σ_{Y} respectively denote a standard deviation of X and a standard deviation of Y; and
screening the preferred features from the correlated features of the wind power, the photovoltaic power and the electric-thermal loads according to the correlation degree ρ_{XY}.

4. The control method for an electric-thermal integrated energy system according to claim 1, wherein a method for constructing the objective function of the integrated energy system comprises:
normalizing the sum f₁ of absolute deviations of node voltages of the integrated energy system at different times into F₁; and
integrating an electricity selling cost C_{E}, a gas purchase cost C_{GAS}, a device operating cost C_{OP} and a wind and photovoltaic power curtailment penalty cost C_{GWP} into an economic cost f₂, and normalizing f₂ into F₂;
wherein, a formula for constructing the objective function is:
$$\{ \begin{matrix}F = min ( {λ}_{1} {F}_{1} + {λ}_{2} {F}_{2} ) \\ {F}_{1} = \frac{{f}_{1}}{{f}_{1}^{max}} \\ {F}_{2} = \frac{{f}_{2}}{{f}_{2}^{max}} \\ {f}_{1} = {\sum }_{i = 1}^{{N}_{V}} {\sum }_{t = 1}^{T} \vert {\tilde{V}}_{i , B} \vert \\ {f}_{2} = {C}_{E} + {C}_{G A S} + {C}_{O P} + {C}_{G W P}\end{matrix}$$
where, λ₁ and λ₂ are respectively weights of F₁ and F₂, f₁^{max} is a maximum value of the sum of the absolute deviations of the node voltages of the integrated energy system, is a maximum power output cost of devices in the integrated energy system, f₂^{max} is a total operating time of the integrated energy system, N^{V} is the number of electric nodes, and \tilde{V}_{i,B}^{t} is a difference between the voltage of an i^{th} electric node at a time t and a safety margin.

5. The control method for an electric-thermal integrated energy system according to claim 4, wherein the difference \tilde{V}_{i,B}^{t} between the voltage of the i^{th} electric node at the time t and the safety margin is calculated by:
$${\tilde{V}}_{i , B}^{t} = \{ \begin{matrix}{V}_{i , B}^{t} - {V}_{min} & , {V}_{i , B}^{t} < {V}_{min} \\ 0 & , {V}_{min} \leq {V}_{i , B}^{t} \leq {V}_{max} \\ {V}_{i , B}^{t} - {V}_{max} & , {V}_{i , B}^{t} > {V}_{max}\end{matrix}$$
where, V_{i,B}^{t} denotes a per-unit value of the voltage of the i^{th} electric node at the time t, Vₘₐₓ denotes an upper limit of the per-unit value of the node voltage, and Vₘᵢₙ denotes a lower limit of the per-unit value of the node voltage.

6. The control method for an electric-thermal integrated energy system according to claim 5, wherein under the influence of a heat network, the per-unit value V_{i,B}^{t} of the voltage of i^{th} electric node is corrected by means of a Newton-Raphson method as follows:
relative injected powers of the electric nodes are expressed as:
$$\{ \begin{matrix}{P}_{i} = {P}_{chp , i} + {P}_{es , i} + {P}_{wd , i} + {P}_{pv , i} - {P}_{eb , i} - {P}_{load , i} \\ {Q}_{i} = {Q}_{chp , i} + {Q}_{es , i} + {Q}_{wd , i} + {Q}_{pv , i} - {Q}_{eb , i} - {Q}_{load , i}\end{matrix}$$
where, Pᵢ and Qᵢ respectively denote an active power and a reactive power injected into the i^{th} electric node, P_{chp,i} and Q_{chp,i} respectively denote an active power and a reactive power of a CHP unit in the i^{th} electric node, P_{es,i} and Q_{es,i} respectively denote an active power and a reactive power of a storage battery in the i^{th} electric node, and Q_{wd,i} respectively denote an active power and a reactive power of a wind generator in the i^{th} electric node, P_{pv,i} and Q_{pv,i} respectively denote an active power and a reactive power of a photovoltaic output of the i^{th} electric node, p_{eb,i} and Q_{eb,i} respectively denote an active power and a reactive power of an electric boiler in the i^{th} electric node, and P_{load,i} and Q_{load,i} respectively denote an active power and a reactive power of an electric load in the i^{th} electric node;
error equations of the electric nodes are calculated and expressed as:
$$\{ \begin{matrix}Δ {P}_{i} = {P}_{is} - {V}_{i} {\sum }_{j ∈ i} {V}_{j} ( {G}_{ij} cos {θ}_{ij} + {B}_{ij} sin {θ}_{ij} ) \\ Δ Q = {Q}_{is} - {V}_{i} {\sum }_{j ∈ i} {V}_{j} ( {G}_{ij} cos {θ}_{ij} - {B}_{ij} sin {θ}_{ij} )\end{matrix}$$
where, Pᵢₛ and Qᵢₛ are an active power and a reactive power set for the i^{th} electric node, Vᵢ and Vⱼ are respectively a voltage injected into the i^{th} electric node and a voltage injected into a j^{th} electric node, and Gᵢⱼ, Bᵢⱼ and θᵢⱼ are respectively a conductance, a susceptance and a phase angle difference between the i^{th} electric node and the j^{th} electric node;
a correction equation simplified based on the Newton-Raphson method is:
$$[ \begin{matrix}Δ P \\ Δ Q\end{matrix} ] = — [ \begin{matrix}\frac{\partial Δ P}{\partial θ} & \frac{\partial Δ P}{\partial V} V \\ \frac{\partial Δ Q}{\partial θ} & \frac{\partial Δ Q}{\partial V} V\end{matrix} ] [ \begin{matrix}Δθ \\ \frac{Δ V}{V}\end{matrix} ]$$
a phase angle allowance Δθ and a phase angle allowance ΔV of each electric node are calculated according to the correction equation, the phase angle and voltage of each electric node are corrected repeatedly, and when ΔPᵢ and ΔQᵢ are both less than ε, correction is stopped, and a final phase angle and a final voltage of each electric node are obtained; ε denotes a permissible error of a power unbalance of the nodes.

7. The control method for an electric-thermal integrated energy system according to claim 4, wherein the device operating cost C_{OP} is calculated by:
$${C}_{O P} = {\sum }_{i = 1}^{{N}_{w d}} {\sum }_{t = 1}^{T} {O}_{chp} {P}_{wd , i}^{t} + {\sum }_{i = 1}^{{N}_{pv}} {\sum }_{t = 1}^{T} {O}_{p v} {P}_{pv , i}^{t} + {\sum }_{i = 1}^{{N}_{es}} {\sum }_{t = 1}^{T} {O}_{e s} {P}_{es , i}^{t} + {\sum }_{i = 1}^{{N}_{chp}} {\sum }_{t = 1}^{T} {O}_{chp} {P}_{chp , i}^{t} + {\sum }_{i = 1}^{{N}_{hs}} {\sum }_{t = 1}^{T} {O}_{hs} {P}_{hs , i}^{h , t} + {\sum }_{i = 1}^{{N}_{eb}} {\sum }_{t = 1}^{T} {O}_{eb} {P}_{eb , i}^{t}$$
where, N_{wd}, Nₚᵥ, Nₑₛ, Nₕₛ and N_{eb} respectively denote the number of wind generation units, the number of photovoltaic generation units, the number of power storage devices, the number of heat storage devices and the number of electric boilers, O_{wd}, Oₚᵥ, Oₑₛ, O_{chp}, Oₕₛ and O_{eb} respectively denote an operating cost coefficient of the wind generation units, an operating cost coefficient of the photovoltaic generation units, an operating cost coefficient of the power storage devices, an operating cost coefficient of the heat storage devices and an operating cost coefficient of the electric boiler P_{wd,i}^{t}, P_{pv,i}^{t}, P_{es,i}^{t} and P_{chp,i}^{t} respectively denote electric power generated by the wind generation units, electric power generated by the photovoltaic generation units, electric power generated by the power storage devices and electric power generated by the CUP units, and P_{hs,i}^{h,t} and P_{eb,i}^{t} respectively denote heat power output by the heat storage devices and heat power output by the electric boilers.

8. The control method for an electric-thermal integrated energy system according to claim 7, wherein the wind and photovoltaic power curtailment penalty cost C_{GWP} is calculated by:
$${C}_{GWP} = {\sum }_{i = 1}^{{N}_{wd}} {\sum }_{t}^{T} {α}_{wd} ( {\overline{P}}_{wd \cdot i}^{t} - {P}_{wd \cdot i}^{t} ) + {\sum }_{i = 1}^{{N}_{pv}} {{\sum }_{t}}^{T} {α}_{pv} ( {\overline{P}}_{pv \cdot i}^{t} - {P}_{pv \cdot i}^{t} )$$
where, α_{wd} and αₚᵥ respectively denote a wind power curtailment penalty cost and a photovoltaic power curtailment penalty cost, and P̅_{wd}^{t} and P̅ₚᵥ^{t} respectively denote a predicted value of wind power and a predicted value of photovoltaic power.

9. The control method for an electric-thermal integrated energy system according to claim 1, wherein the added power network constraints for optimal scheduling comprise an active power balance constraint, an electric node voltage constraint, a branch transmission power constraint and a branch power loss constraint of a power network, and the added heat network constraints comprise a power balance constraint and a pipe heat loss constraint of a heat network.

10. The control method for an electric-thermal integrated energy system according to claim 1, wherein a method for iterating and updating the weights and thresholds in the BP neural network by means of the SA-PSO algorithm to obtain the SA-PSO-BP neural network comprise:
initializing the weights and thresholds in the BP neural network; taking lengths of the weights and thresholds in the BP neural network as dimensions of a particle swarm, taking the weights and thresholds as positions of particles, and initializing a weight w, learning rates c₁ and c₂, a position X and a speed v of the particle swarm and a temperature T and annealing coefficient K of simulated annealing;
taking a prediction error in the training process of the neural network as a fitness F of the particle swarm, applying a stochastic disturbance to the particles to obtain new particles x_{new}, and if a new fitness Fₓ_{_{new}} is less than or equal to an existing fitness Fₓ, using the new fitness Fₓ_{_{new}} as an optimal fitness;
if Fₓ_{_{new}}>Fₓ and exp (−F−F)/TK≤rand( ), using the new fitness Fₓ_{_{new}} as the optimal fitness; if Fₓ_{_{new}}>Fₓ and exp (−(F−F)/TK)≤rand( ), using the existing fitness Fₓ as the optimal fitness, wherein exp ( ) denotes an exponent operation with a natural logarithm e as a base, and rand ( ) denotes a random function for generating random numbers; and
iterating and updating the weight w, the learning rates c₁ and c₂, the position X and the speed v of the particle swarm and the fitness F of the particle swarm; when the number of iterations reaches a preset value, outputting a global optimal solution F_{g} and a corresponding BP neural network, and taking the trained BP neural network as the SA-PSO-BP neural network.

11. The control method for an electric-thermal integrated energy system according to claim 3, wherein a method for constructing the objective function of the integrated energy system comprises:
normalizing the sum f₁ of absolute deviations of node voltages of the integrated energy system at different times into F₁; and
integrating an electricity selling cost C_{E}, a gas purchase cost C_{GAS}, a device operating cost C_{OP} and a wind and photovoltaic power curtailment penalty cost C_{GWP} into an economic cost f₂, and normalizing f₂ into F₂;
wherein, a formula for constructing the objective function is:
$$\{ \begin{matrix}F = min ( {λ}_{1} {F}_{1} + {λ}_{2} {F}_{2} ) \\ {F}_{1} = \frac{{f}_{1}}{{f}_{1}^{max}} \\ {F}_{2} = \frac{{f}_{2}}{{f}_{2}^{max}} \\ {f}_{1} = {\sum }_{i = 1}^{{N}_{V}} {\sum }_{t = 1}^{T} \vert {\tilde{V}}_{i , B} \vert \\ {f}_{2} = {C}_{E} + {C}_{G A S} + {C}_{O P} + {C}_{G W P}\end{matrix}$$
where, λ₁ and λ₂ are respectively weights of F₁ and F₂, f₁^{max} is a maximum value of the sum of the absolute deviations of the node voltages of the integrated energy system, f₂^{max} is a maximum power output cost of devices in the integrated energy system, T is a total operating time of the integrated energy system, N_{V} is the number of electric nodes, and \tilde{V}_{i,B}^{t} is a difference between the voltage of an i^{th} electric node at a time t and a safety margin.

12. The control method for an electric-thermal integrated energy system according to claim 9, wherein a method for iterating and updating the weights and thresholds in the BP neural network by means of the SA-PSO algorithm to obtain the SA-PSO-BP neural network comprise:
initializing the weights and thresholds in the BP neural network; taking lengths of the weights and thresholds in the BP neural network as dimensions of a particle swarm, taking the weights and thresholds as positions of particles, and initializing a weight w, learning rates c₁ and c₂, a position x and a speed v of the particle swarm and a temperature T and annealing coefficient K of simulated annealing;
taking a prediction error in the training process of the neural network as a fitness F of the particle swarm, applying a stochastic disturbance to the particles to obtain new particles x_{new}, and if a new fitness Fₓ_{_{new}} is less than or equal to an existing fitness Fₓ, using the new fitness Fₓ_{_{new}} as an optimal fitness;
if Fₓ_{_{new}}>Fₓ and ex(−(F−F/TK≤rand ( ), using the new fitness Fₓ_{_{new}} as the optimal fitness; if Fₓ_{_{new}}>Fₓ and exp (−(F−F)/TK≤rand ( ), using the existing fitness Fₓ as the optimal fitness, wherein exp ( ) denotes an exponent operation with a natural logarithm e as a base, and rand ( ) denotes a random function for generating random numbers; and
iterating and updating the weight w, the learning rates c₁ and c₂, the position x and the speed v of the particle swarm and the fitness F of the particle swarm; when the number of iterations reaches a preset value, outputting a global optimal solution F_{g} and a corresponding BP neural network, and taking the trained BP neural network as the SA-PSO-BP neural network.
